(19) United States
(12) Patent Application Publication
(10) Pub. No.: US 2024/0154130 A1
(43) Pub. Date: May 9, 2024

(54) SECONDARY BATTERY

(71) Applicant: AweXome Ray, Inc., Anyang-si (KR)

(72) Inventors: Hong Soo CHOI, Seoul (KR); Young Bae KIM, Anyang-si (KR); Keun Soo JEONG, Seoul (KR); Se Hoon GIHM, Seongnam-si (KR)

(21) Appl. No.: 18/070,192

(22) Filed: Nov. 28, 2022

(30) Foreign Application Priority Data
Nov. 7, 2022 (KR) 10-2022-0146983

(51) Int. Cl. H01M 4/74; H01M 4/66; H01M 10/0525; H01M 10/0562

(52) U.S. Cl. CPC H01M 4/747; H01M 4/663; H01M 10/0525; H01M 10/0562; H01M 2004/027

(57) ABSTRACT

To increase the energy density of a secondary battery, minimize the possibility of fire and explosion, and minimize the dendrite formation problem, provided is a secondary battery, which includes a cathode material and an anode material, wherein the anode material includes an anode structure that is a sheet in which a plurality of yarns formed of carbon nanotube (CNT) fibers are woven.

### CROSS-REFERENCE TO RELATED APPLICATION(S)

This application claims the benefit of Korean Patent Application No. 10-2022-0146983, filed on Nov. 7, 2022, in the Korean Intellectual Property Office, the disclosure of which is incorporated herein by reference.

### BACKGROUND

### Technical Field

Example embodiments relate to a secondary battery.

### Description of the Related Art

As the supply of electric vehicles using secondary batteries as a raw material for mileage spreads and the need for electric vehicles increases, interest in secondary batteries amounted on electric vehicles is also increasing.

The capacity of a secondary battery is directly related to the operating time of a target device, such as the mileage of an electric vehicle. At the same time, the problem of increasing the volume and the weight of the target device must also be considered, and thus the demand for secondary batteries with high energy density is quite high.

Further, there is a significant demand for a secondary battery having high stability by minimizing the possibility of the fire and explosion.

Research on solid-state batteries is active as a way to realize high-capacity and high-stability secondary batteries.

### BRIEF SUMMARY

In a solid-state battery, an electrolyte of a battery composed of a liquid electrolyte is replaced with a solid electrolyte. When a solid electrolyte is used instead of a liquid electrolyte, since there is no risk of electrolyte leakage and a separator for preventing contact between the positive electrode and the negative electrode is not required, the battery may be miniaturized.

However, during the repeated charging process, dendrites (lithium metal crystals) are generated due to the imbalance of charges and non-uniform interfacial contract that occurs at the interface between the electrodes and the electrolyte, and thus the solid-state battery has the matter of causing an electrode short circuit and rapid performance degradation.

One or more embodiments of the present disclosure addresses the various technical problems in the related art including the problems identified above.

An aspect provides a secondary battery with high energy density.

Another aspect also provides a secondary battery that minimizes the possibility of fire and explosion.

Further, another aspect provides a secondary battery that minimizes the dendrite formation problem that occurs in realizing a solid-state battery.

According to an aspect, there is provided a secondary battery including a cathode material and an anode material, wherein the anode material includes an anode structure that is a sheet in which a plurality of yarns formed of carbon nanotube (CNT) fibers are woven.

According to another aspect, the anode structure may be an anode current collector of a lithium ion battery.

According to an aspect, there is provided an anode-free secondary battery, which includes a cathode material, an electrolyte and an anode structure that is a sheet in which a plurality of yarns formed of CNT fibers included in the electrolyte are woven.

According to another aspect, the electrolyte may be a solid.

Additional aspects of example embodiments will be set forth in part in the description which follows and, in part, will be apparent from the description, or may be learned by practice of the disclosure.

According to example embodiments, it is possible to increase the energy density of a secondary battery.

Further, according to example embodiments, it is possible to minimize the possibility of fire and explosion of a second battery.

Further, according to example embodiments, it is possible to minimize the dendrite formation problem that occurs in realizing a solid-state battery.

### BRIEF DESCRIPTION OF THE SEVERAL VIEWS OF THE DRAWINGS

These and/or other aspects, features, and advantages of the disclosure will become apparent and more readily appreciated from the following description of example embodiments, taken in conjunction with the accompanying drawings of which:

FIG. 1 is a conceptual view of an existing lithium ion battery;

FIGS. 2 and 3 schematically illustrate CNT-based sheets related to the present disclosure;

FIG. 4 is a partial front view of an anode structure according to an example embodiment of the present disclosure;

FIG. 5 is a partial perspective view of an anode structure according to another example embodiment of the present disclosure;

FIG. 6 is a conceptual diagram of one form of a secondary battery to which an anode structure is applied;

FIGS. 7A and 7B show photographs of a twisted yarn and a braided yarn according to example embodiments of the present disclosure;

FIGS. 8A to 8D illustrate a process of forming an anode structure according to an example embodiment of the present disclosure;

FIGS. 9A to 9D illustrate mechanical properties according to the types of yarns constituting the anode structure;

FIG. 10 illustrates a graph showing electrical properties when the anode structure is formed of twisted yarns and when the anode structure is formed of braided yarns;

FIG. 11 illustrates a graph showing linear density when the anode structure is formed of twisted yarns and when form of braided yarns; and

FIGS. 12 and 13 are conceptual diagrams illustrating before and after lithium precipitation of an anode-free secondary battery and a solid-state battery related to the present disclosure.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

The suffixes “module” and “part” for the components used in the following description are given or mixed in consideration of the ease of writing the specification, and do not have distinct meanings or roles by themselves. In addition, in describing the example embodiments disclosed in the specification, if it is determined that detailed description of related known technologies may obscure the gist of the example embodiments disclosed in the specification, the detailed description thereof will be omitted. In addition, the accompanying drawings are only for easy understanding of the example embodiments disclosed in the specification, and the technical idea disclosed herein is not limited by the accompanying drawings, and all modifications included in the scope of the present disclosure should be understood to include equivalents or substitutes.

The terms such as “first” and “second” as used herein may use corresponding components regardless of importance or an order and are used to distinguish a component from another without limiting the components. These terms may be used for the purpose of distinguishing one element from another element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element.

A singular expression includes a plural expression unless the context clearly dictates otherwise.

In the entire present disclosure, the terms “have,” “may have,” “include,” and “may include” as used herein indicate the presence of corresponding features (for example, elements such as numerical values, functions, operations, or parts), and do not preclude the presence of additional features.

Expression “at least one of a, b and c” described throughout the specification may include “a alone,” “b alone,” “c alone,” “a and b,” “a and c,” “b and c” or “all of a, b and c.”

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments of the present disclosure will be described in detail with reference to the drawings.

A secondary battery refers to a device that converts electrical energy into chemical energy and store (or, charges), and converts stored chemical energy back into electrical energy and releases (or, discharges). A secondary battery may be represented in various ways, and secondary batteries may be classified into lead acid batteries, nickel cadmium batteries, nickel hydrogen batteries and lithium ion batteries based on materials.

In particular, lithium ion batteries have high energy density when the mass and the volume are considered in comparison to other batteries, and lithium ion batteries are advantageous for high-speed and high-rate charging and discharging, so widely used in portable devices.

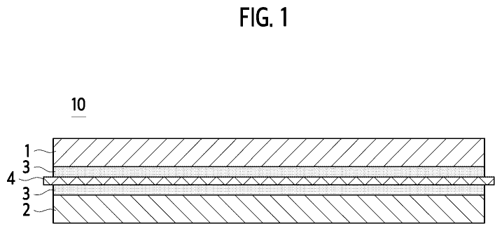

FIG. 1 is a conceptual view of an existing lithium ion battery 10.

The lithium ion battery 10 is largely composed of a cathode material 1, an anode material 2, electrolyte solution 3 and a separator 4. The cathode material 1 determines the capacity and average voltage of the lithium ion battery 10 as a source of lithium ions. The anode material 2 stores and releases lithium ions from the cathode material 1, allowing current to flow through an external circuit. The electrolyte solution 3 helps the ions to move smoothly between the cathode material 1 and the anode material 2. The separator 4 blocks the contact between the cathode material 1 and the anode material 2.

More specifically, an active material, a conductive material, a binder and a current collector may constitute the cathode material 1 or the anode material 2.

The active material refers to a material directly involved in the electrode reaction of a battery. The conductive material serves to increase the conductivity of the active material, and the binder serves to bind the conductive material and the active material to the current collector (or, a substrate). The current collector corresponds to an element that serves as a path through which electrons flow smoothly.

A typical active material of the cathode material 1 is lithium. Since lithium has unstable reactivity, lithium oxide combined with oxygen may be used as an active material. Aluminum may be used for the current collector of the cathode material 1.

Meanwhile, the active material of the anode material 2 may include graphite, and the current collector may include a copper (Cu) material. Graphite satisfies structural stability and low electrochemical reactivity, which are the conditions that the active material of the anode material 2 should have. Further, graphite can store a lot of lithium ions and is widely used because of its low price. The active material of the anode material 2 allows current to flow through an external circuit while reversibly absorbing or releasing lithium ions from the cathode material 1.

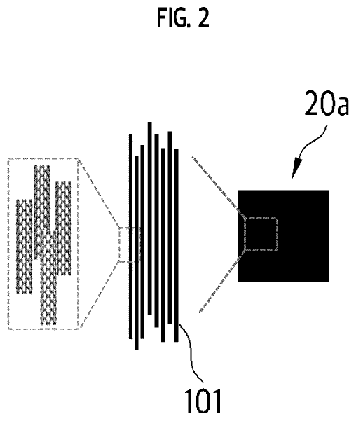

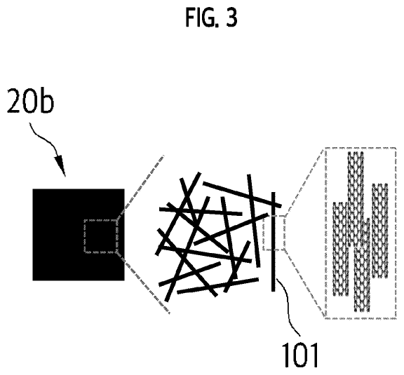

FIGS. 2 and 3 schematically illustrate CNT(carbon nanotube)-based sheets 20 related to the present disclosure.

The current collector of the anode material 2 may be a CNT(carbon nanotube)-based sheet 20 instead of copper.

If the CNT-based sheet 20 is used as a current collector of a lithium ion battery, unlike a anode material of an existing secondary battery, there is the advantage that the binder may be omitted and most of the excellent electrical properties of CNTs may be utilized. Specifically, the CNT-based sheet 20 has high electrical conductivity, low density and excellent electrochemical stability. Specifically, CNT current collectors with low density may contribute to weight reduction of lithium ion batteries.

The CNT-based sheet 20 may be an anisotropic sheet 20a in which CNT fibers constituting the sheet have directionality, or the CNT-based sheet 20 may be a non-woven sheet 20b as illustrated in FIG. 3. However, despite the above advantages, these CNT-based sheet 20 has some disadvantages when used as a current collector. Specifically, in the case of the anisotropic sheet 20a having a directionality as illustrated in FIG. 2, there is a problem in that mechanical properties are deteriorated in the vertical direction of the aligned direction. In the case of the non-woven sheet 20b as illustrated in FIG. 3, overall mechanical properties may be insufficient, or non-uniformity may occur due to partial differences in physical properties.

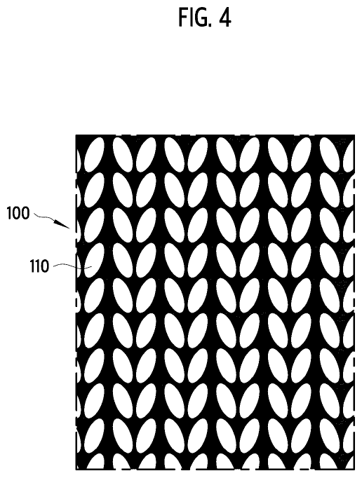

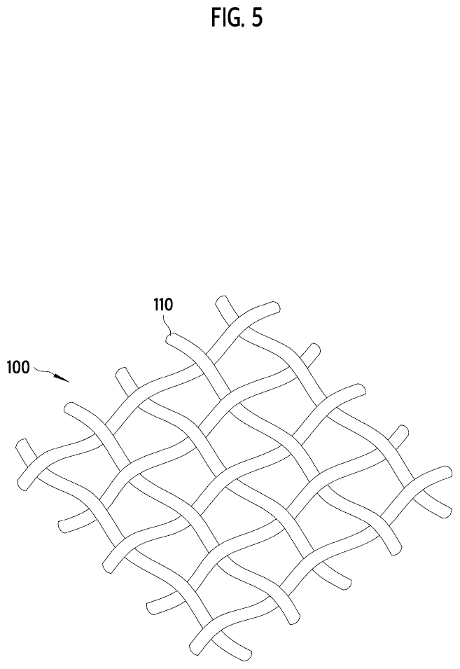

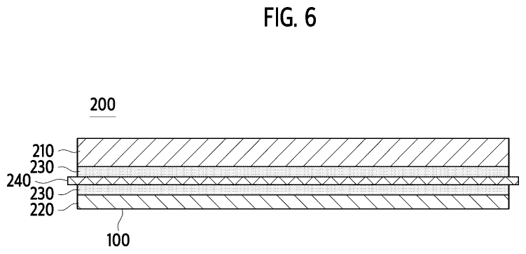

FIG. 4 is a partial front view of an anode structure 100 according to an example embodiment of the present disclosure. FIG. 5 is a partial perspective view of the anode structure 100 according to another example embodiment of the present disclosure. FIG. 6 is a conceptual diagram of one form of a secondary battery 200 to which the anode structure 100 is applied.

Following embodiments propose the anode structure 100 that complements the above CNT-based sheet. The anode structure 100 is included in the anode and refers to a structure that may be used as a current collector or a precipitation-type anode to be described later.

The anode structure 100 may be a sheet in which a plurality of yarns 110 formed of CNT fibers are woven, that is, a CNT-based woven structure.

The CNT-based woven structure may have improved electrical, mechanical properties, and more uniform properties.

Below, a specific manufacturing method and a structure of the CNT-based woven structure will be described.

The anode structure 100 may be a sheet in which a plurality of yarns 110 formed of CNT fibers are woven. The anode structure 100 may have a uniform pattern.

The anode structure 100 may be woven in a variety of ways. For example, the anode structure may be woven in various ways, such as plain weaving, twill weaving and satin weaving. In other words, the anode structure 100 may be formed without being limited to any particular weaving method as long as a regular texture can be formed. The anode structure 100 formed by weaving may take the form of a thin and wide sheet, and the stiffness may depends on the weaving method. FIGS. 4 and 5 conceptually illustrate some of the anode structures 100 that may be woven in the various ways described. The anode structure 100 of the present disclosure may be any woven structure to the extent that is not inconsistent with the described or to-be-explained features.

The weaving material may take the form of a sheet only with a structure of the plurality of yarns 110 without additional materials or physical/chemical processing. However, if necessary, additional material or physical/chemical processing may be added. In this case, the sheet structure may be made more rigid.

The sheet-shaped anode structure 100 formed of CNT fibers has high electrical conductivity, low density and excellent electrochemical stability. Specifically, since the anode structure 100 formed by weaving does not have only one direction, there is a low possibility of a problem of a sudden drop in mechanical properties in one direction. Further, since the anode structure 100 formed by weaving has proper directionality, uniformity of mechanical properties may be guaranteed.

Since the woven sheet-shaped anode structure 100 has uniform physical properties, manufacturing deviation may also be minimized. In other words, since the anode structure 100 is woven by the same method and has the same pattern, the weight, the volume and the thickness between the manufactured anode structures 100 are constant, which enables uniform physical properties of the secondary battery 200.

Further, since the woven sheet-shaped anode structure 100 has a reinforced structure in which a plurality of yarns 110 are fastened to each other, the anode structure 100 may have improved durability.

The anode structure 100 having the above characteristics may be included in an anode material 220 of the second battery 200. The anode structure 100 may serve as a skeleton in the anode material 220, for example, a scaffold.

In the anode material 220, the empty space formed by the anode structure 100 may be emptied as it is, or may be filled with a solid electrolyte, or may be filled with a liquid electrolyte.

Further, the empty space formed by the anode structure 100 may be filled with at least one of an active material, a polymer material such as a binder, and a conductive material (metal nanoparticles or carbon nanoparticles).

The secondary battery 200 of the present disclosure may include a cathode material 210, the anode material 220, an electrolyte 230 and a separator 240. The characteristics of each element are the same with the range that does not contradict the characteristics of the elements of the lithium ion battery 10 described with reference to FIG. 1. Alternatively, the secondary battery 200 of the present disclosure may not include the separator 240.

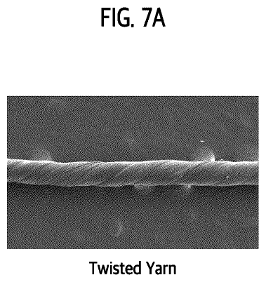

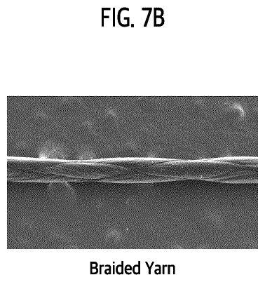

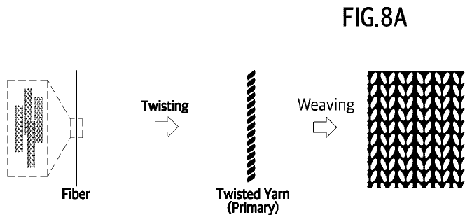

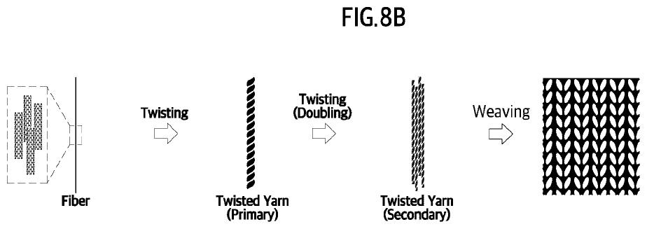

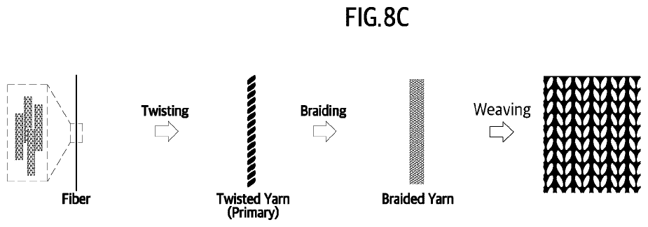

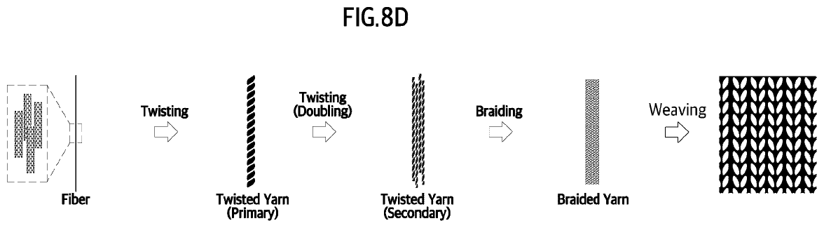

FIGS. 7A and 7B shows photographs of a twisted yarn and a braided yarn according to example embodiments of the present disclosure. FIGS. 8A to 8D illustrate a process of forming an anode structure according to an example embodiment of the present disclosure.

A yarn may be defined as a plurality of CNT fiber threads that are combined (e.g., braided or twisted) together. The yarn may be defined as a yarn in which a fiber thread and a fiber thread are combined together, as well as yarns in which fiber threads are combined together are combined together again.

The anode structure may be made of the twisted yarn of FIG. 7A or the braided yarn of FIG. 7B. Specifically, the anode structure may be formed by weaving a plurality of twisted yarns or may be formed by weaving a plurality of braided yarns. The twisted yarn has the advantage of being easily manufactured, and the braided yarn has the advantage of excellent mechanical and electrical properties.

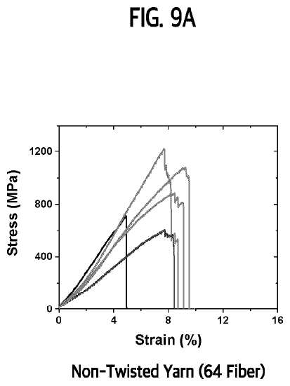

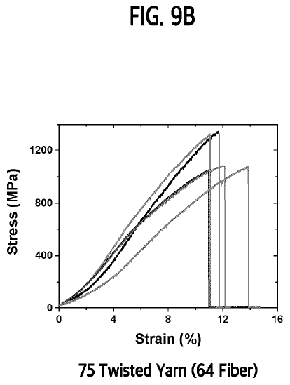

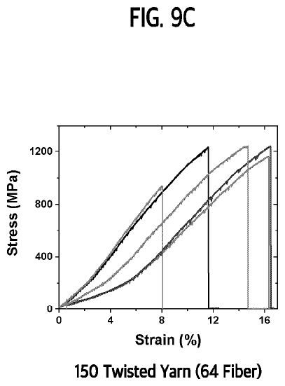

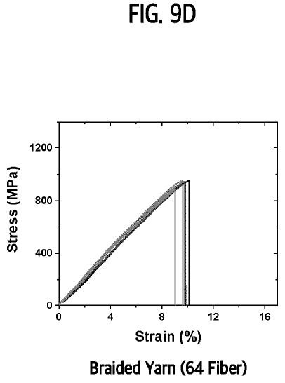

The physical properties of the twisted yarn and the braided yarn will be described in detail with reference to FIGS. 9 to 11.

The anode structure may be formed by weaving a plurality of twisted yarns or by weaving a plurality of braided yarns. The yarn of a unit to be described hereinafter is defined as indicating a yarn that is just before woven into the anode structure.

The unit yarn of the anode structure woven through the processes of FIG. 8A and FIG. 8B is a twisted yarn.

Referring to FIG. 8A, the unit yarn constituting the anode structure may be a primary twisted yarn. The primary twisted yarn is formed by a plurality of CNT threads being wired through twisting.

Referring to FIG. 8B, the unit yarn constituting the anode structure may be a secondary twisted yarn. The secondary twisted yarn is formed by a plurality of the primary twisted yarns being wired through twisting.

In particular, “twisting” to form a secondary twisted yarn is called “doubling.”

Meanwhile, referring to the processes illustrated in FIGS. 8C and 8D, the unit yarn constituting the anode structure may be a braided yarn. The braided yarn may be formed by braiding of the plurality of primary twisted yarns as illustrated in FIG. 8C, or may be formed by braiding the plurality of secondary twisted yarns as illustrated in FIG. 8D. The characteristics of the primary twisted yarn and the secondary twisted yarn described in FIGS. 8C and 8D are the same as the characteristics of the primary twisted yarn and the secondary twisted yarn described in FIGS. 8A and 8B.

However, the anode structure is not limited to the above shape or the structure illustrated in FIG. 8. As long as a unit yarn forming an anode structure in the form of a sheet can be formed by weaving, there is no limitation on how to form an anode structure. For example, the anode structure may be formed in various combinations of the methods illustrated in FIG. 8A to FIG. 8D, or the anode structure may be formed in a method not illustrated in FIG. 8A to FIG. 8D.

FIGS. 9A to 9D illustrates mechanical properties according to the types of yarns constituting the anode structure.

FIG. 9A to FIG. 9D illustrate strain-stress curves according to the types of yarns constituting the anode structure of the anode structure. The data are illustrated after experiments are performed multiple times for each case. FIG. 9A illustrates a case in which strain is applied to a yarn (a non-twisted yarn) in which 64 CNT threads are simply collected. FIG. 9B illustrates a case in which strain is applied to a twisted yarn that is formed by 64 CNT threads being twisted 75 times. FIG. 9C illustrates a case in which strain is applied to a twisted yarn that is formed by 64 CNT threads being twisted 150 times. FIG. 9D illustrates a case in which strain is applied to a braided yarn that is formed by 64 CNT threads being braided.

FIG. 9A to FIG. 9C illustrate that when strain is applied to a simple collection of CNT threads (a not twisted yarn) and a twisted yarn formed by twisting CNT threads, each trail shows different stress characteristics. Meanwhile, FIG. 9D illustrates that when strain is applied to the braided yarn that is formed by the CNT threads being braided, there is little difference in the stress characteristics for each trial.

Table 1 below shows the numerical representation of mechanical properties according to the type of unit yarns constituting the anode structure discussed above.

TABLE 1

| | Strain (%) | Stress (MPa) | Modulus (GPa) |
|---|---|---|---|
| Non-twisted yarn | 7.62 ± 1.47 | 901.5 ± 227.0 | 9.16 ± 2.05 |
| 75 times twisted yarn | 11.94 ± 1.06 | 1177.0 ± 130.1 | 6.15 ± 1.35 |
| 150 times twisted yarn | 13.51 ± 3.07 | 1163.9 ± 116.2 | 5.34 ± 2.43 |
| Braided yarn | 9.67 ± 0.36 | 935.8 ± 26.5 | 9.55 ± 1.06 |

Table 1 shows that the deviation values of strain and stress are significantly lower in the case where the unit yarn constituting the anode structure is formed of braided yarns than in the other cases. Further, with regard to the modulus values, which are values of the ratio of change in stress according to strain change, when the yarn constituting the anode structure is formed of braided yarns, the deviation value is the smallest, when compared to the other cases.

Referring to FIG. 9 and Table 1, when the unit yarn constituting the anode structure is formed of braided yarns, the uniformity of mechanical properties may be improved, when compared to simply gathering CNT threads (non-twisted yarn) or forming the yarns into a twisted yarn.

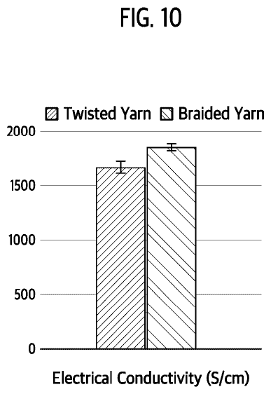

FIG. 10 illustrates a graph showing electrical properties when the anode structure is formed of twisted yarns and when the anode structure is formed of braided yarns.

Specifically, FIG. 10 illustrates electrical conductivity according to the type of unit yarn constituting the anode structure.

Table 2 below shows figures of electrical properties when the anode structure is formed of twisted yarns and when formed of braided yarns.

TABLE 2

| | Electrical conductivity (S/cm) | |
|---|---|---|
| | | Std.p(Population |
| | Avg(Average) | Standard Deviation) |
| Twisted yarn | 1670.8 | 53.6 |
| Braided yarn | 1855.3 | 27.8 |

FIG. 10 and Table 2 show that when the anode structure is formed of braided yarns, the electrical conductivity is higher and the standard deviation thereof is small compared to the case of the twisted yarns. In other words, when the anode structure is formed based on braided yarns, the uniformity of electrical conductivity may be further improved.

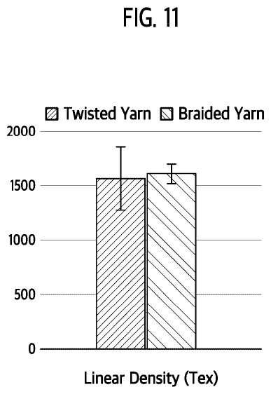

FIG. 11 illustrates a graph showing linear density when the anode structure is formed of twisted yarns and when form of braided yarns.

Table 3 below shows the figures of the linear density when the anode structure is formed of twisted yarns and when formed of braided yarns.

TABLE 3

| | Linear density (Tex) | |
|---|---|---|
| | Avg | Std.p |
| Twisted yarn | 15.67 | 2.9 |
| Braided yarn | 16.11 | 0.68 |

FIG. 11 and Table 3 show that when the anode structure is formed of braided yarns, the standard deviation of linear density is smaller than the anode structure of twisted yarns. If the linear density is changed, the amount or resistance of the current flowing through the anode structure may be changed, and thus it may be understood that the more uniform the linear density is, the more uniform the electrical characteristics are. In other words, if the anode structure is formed of braided yarns, as the uniformity of the linear density is excellent, the electrical characteristics may also be uniform.

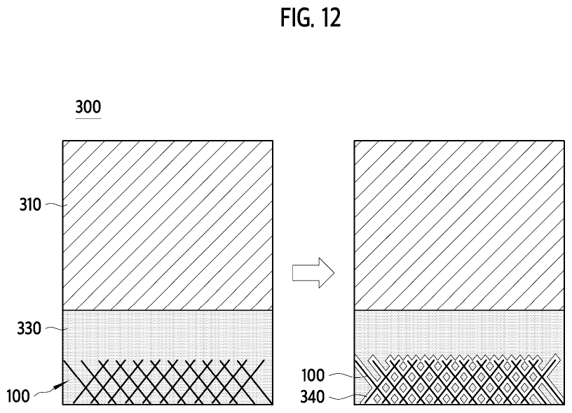

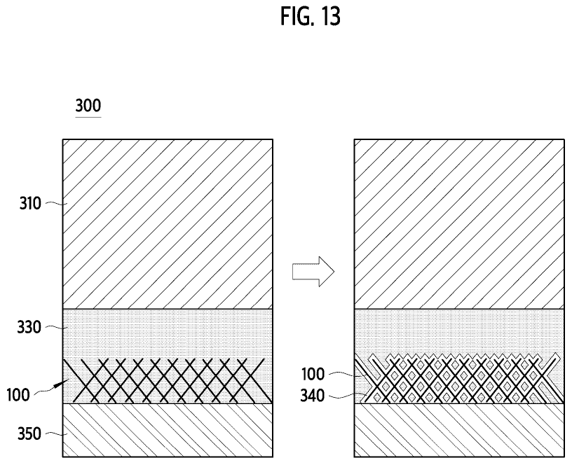

FIGS. 12 and 13 are a conceptual diagrams illustrating before and after lithium precipitation of an anode-free secondary battery or a solid-state battery related to the present disclosure.

The above-described anode structure 100 may also be applied to an anode-free secondary battery 300 or to a solid-state battery 300.

The solid-state battery has advantages. Since the solid-state battery has a solid electrolyte, the risk of electrolyte leakage is eliminated, and in the solid-state battery, a separator that prevents contact between the positive electrode and the negative electrode can be omitted, the weight and the volume of the battery may be reduced. In other words, the solid-state battery has the advantages of easy implementation of a large-capacity battery and high stability. One way to implement a solid-state battery is to use lithium metal as an anode material. Lithium metal has oxidation/reduction reactivity and density lower than those of other anode materials, when compared, but lithium metal has higher ion capacity than other anode materials. Thus, it is possible to realize high energy density per volume or per weight with lithium metal. However, despite the advantages, when lithium metal is used, a so-called dendrite phenomenon in which lithium crystals form on the surface of the anode material may occur during the charging of a solid-state battery. When the dendrite formations occur, irreversible lithium metal is produced, and there is a change in volume. Due to the dendrite formations, the solid-state battery has characteristics of low coulombic efficiency (in other words, low cycle characteristics) and low interfacial contact, and furthermore, problems such as form strain, heat generation, short circuit and fire may occur.

Thus, the present disclosure provides a secondary battery which is made by applying the anode structure 100 to the anode-free secondary battery 300. The anode structure 100 applied to the anode-free secondary battery 300 simultaneously serves as the above-described current collector and as a precipitation-type anode.

When the anode structure 100 is applied to the solid-state battery 300, as lithium generated by the reduction of lithium ions is deposited in the empty space of the electrode, the volume change of the secondary battery may be minimized.

Further, lithium may be uniformly precipitated on the contact surface with the electrolyte to prevent dendrite formation from occurring. Specifically, when the anode structure 100 in which a plurality of yarns are woven is applied to the solid-state battery 300, compared to the anode structure 100 in the form of a general sheet rather than in a woven form, it has uniform electrical conductivity, thereby maintaining higher charge uniformity. This indicates that the lithium precipitated is uniform depending on the region.

Further, the shape change of the electrode may be minimized through the anode structure 100 which is a fixed type structure. In other words, in an existing battery, as the charging and discharging of the battery were repeated, the anode composite was agglomerated, and this became a factor to strain the shape of the electrode; however, when the anode structure 100 of the present disclosure is applied, the shape change of the electrode may be minimized due to the fixed shape even when charging and discharging are repeated.

Specifically, the anode structure 100 may be provided in a solid electrolyte 330, more specifically, the sulfide-based electrolyte 330, and may be used as a current collector of the anode-free battery.

In other words, the solid-state battery 300 of the present disclosure may include a structure in which a cathode material 310 and the solid electrolyte 330 are sequentially stacked as illustrated in FIG. 12. Alternatively, as illustrated in FIG. 13, the solid-state battery 300 may include a structure in which the cathode material 310, the solid electrolyte 330 and a current collector 350 are sequentially stacked.

The anode structure 100 may be provided in a layer of the solid electrolyte 330. Specifically, the anode structure 100 may be provided to be far from the cathode material 310 or adjacent to a layer of the current collector 350.

In the solid-state battery 300 of the form illustrated in FIG. 12, the solid electrolyte 330 including the anode structure 100 serves as a current collector. In the solid-state battery 300 of the form illustrated in FIG. 13, not only the solid electrolyte 330 layer including the anode structure 100 but also the separate current collector 350 layer may serve as a current collector.

As charging and discharging are repeated, lithium ions may be reduced to form a lithium structure 340 precipitated on the anode structure 100.

By the solid-state battery 300 to which the anode structure 100 is applied, as described above, a low volume change may be realized, and non-mobility and charge uniformity may be ensured.

The example embodiments described in the present disclosure or other example embodiments are not mutually exclusive or distinct. In the above described example embodiments of the present disclosure, or in other example embodiments, each of components or functions may be used together or combined.

For example, component A described in a specific example embodiment and/or drawings may be combined with component B in another example embodiment and/or drawings. In other words, even if a combination between components is not directly descried, the combination may be possible except for the case where it is explained that the combination is impossible.

The above detailed description should not be construed as restrictive in all respect and should be considered as illustrative. The scope of the present disclosure should be determined by a reasonable interpretation of the appended claims, and all modifications within the equivalent scope of the present disclosure are included in the scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A secondary battery, comprising:
a cathode material; and
an anode material,
wherein the anode material includes an anode structure that includes a sheet in which a plurality of yarns formed of carbon nanotube (CNT) fibers are woven.

2. An anode-free secondary battery, comprising:
a cathode material;
an electrolyte; and
an anode structure that includes a sheet in which a plurality of yarns formed of carbon nanotube (CNT) fibers included in the electrolyte are woven.

3. The secondary battery of claim 1, wherein each of the plurality of yarns is a braided yarn.

4. The secondary battery of claim 3,
wherein the braided yarn is formed by a plurality of primary twisted yarns being braided to each other, and
wherein each of the plurality of primary twisted yarns is formed by a plurality of CNT threads being twisted.

5. The second battery of claim 3,
wherein the braided yarn is formed by secondary twisted yarns being braided to each other,
wherein each of the secondary twisted yarns is formed by a plurality of primary twisted yarns being twisted to each other, and
wherein each of the plurality of primary twisted yarns is formed by a plurality of CNT threads being twisted.

6. The secondary battery of claim 1, wherein each of the plurality of yarns is a twisted yarn.

7. The secondary battery of claim 6, wherein the twisted yarn is a primary twisted yarn, which is formed by a plurality of CNT threads being twisted.

8. The secondary battery of claim 6,
wherein the twisted yarn is a secondary twisted yarn, which is formed by primary twisted yarns being twisted to each other, and
wherein each of the primary twisted yarns is formed by a plurality of CNT threads being twisted.

9. The secondary battery of claim 1, wherein the anode structure is an anode current collector of a lithium ion battery.

10. The secondary battery of claim 2, wherein the electrolyte is a solid.

11. The secondary battery of claim 10, wherein the electrolyte includes a sulfide-based material.

12. The secondary battery of claim 1, further comprising no separator.

13. The secondary battery of claim 2, wherein each of the plurality of yarns is a braided yarn.

14. The secondary battery of claim 13,
wherein the braided yarn is formed by a plurality of primary twisted yarns being braided to each other, and
wherein each of the plurality of primary twisted yarns is formed by a plurality of CNT threads being twisted.

15. The second battery of claim 13,
wherein the braided yarn is formed by secondary twisted yarns being braided to each other,
wherein each of the secondary twisted yarns is formed by a plurality of primary twisted yarns being twisted to each other, and
wherein each of the plurality of primary twisted yarns is formed by a plurality of CNT threads being twisted.

16. The secondary battery of claim 2, wherein each of the plurality of yarns is a twisted yarn.

17. The secondary battery of claim 16, wherein the twisted yarn is a primary twisted yarn, which is formed by a plurality of CNT threads being twisted.

18. The secondary battery of claim 16,
wherein the twisted yarn is a secondary twisted yarn, which is formed by primary twisted yarns being twisted to each other, and
wherein each of the primary twisted yarns is formed by a plurality of CNT threads being twisted.
